(19) United States
(12) Patent Application Publication
(10) Pub. No.: US 2006/0050794 A1
(43) Pub. Date: Mar. 9, 2006

(54) Method and apparatus for delivering programme-associated data to generate relevant visual displays for audio contents

(76) Inventors: Jek-Thoon Tan, Yew Mei Green (SG); Sheng Mei Shen, Windermere (SG)

Correspondence Address: LADAS & PARRY, 26 WEST 61ST STREET, NEW YORK, NY, 10023, US

(21) Appl. No.: 10/530,953

(22) PCT Filed: Sep. 25, 2003
(86) PCT No.: PCT/SG03/00233

§ 371 Date: Apr. 8, 2005

(30) Foreign Application Priority Data
Oct. 11, 2002 (SG) 200206227-1

(51) Int. Cl. H04N 7/10; H04N 7/12

(52) U.S. Cl. 375/240.26; 725/32

(57) ABSTRACT

An MPEG audio stream is transmitted together with an MPEG video stream. The audio stream contains an audio signal together with associated audio description data as ancillary data. The video stream contains a video signal together with video description data (e.g. video clips, stills, graphics, text etc) as private data, the video description data not necessarily having anything to do with the video data with which it is transmitted. At reception, the audio and video streams are decoded. The video description data is stored in a memory. The audio signal is played. The audio description data is used to select appropriate video description data for the particular audio signal from the memory or other storage, or from the current incoming video description data. This is then displayed as the audio signal is played.

### TECHNICAL FIELD

The present invention relates to the provision of an audio signal with an associated video signal. In particular, it relates to the use of audio description data, transmitted with an audio signal as part of an audio stream, to select an appropriate video signal to accompany the audio signal during playback.

### BACKGROUND TO THE INVENTION

In digital music media and broadcast applications such as MP3 players and digital audio broadcast, the experience is usually solely audio. When listening to music, people usually tend only to listen, without watching anything. The audio programme is usually played without giving the listener any interesting visual display.

In some standards, ancillary data may be carried within an audio elementary stream for broadcast or storage in audio media. The most common use of ancillary data is programme-associated data, which is data intimately related to the audio signal. Examples of programme-associated data are programme related text, indication of speech or music, special commands to a receiver for synchronisation to the audio programme, and dynamic range control information. The programme-associated data may contain general information such as song title, singer and music company names. It gives relevant facts but is not useful beyond that.

In current digital TV developments, programme-associated data carrying textual and interactive services can be developed for the TV programmes. These solutions cover implementation details including protocols, common API languages, interfaces and recommendations. The programme-associated data are transmitted together with the video and audio content multiplexed within the digital programme or transport stream. In such implementations, relevant programme-associated data must be developed for each TV programme, and there must also be constant monitoring of the multiplexing process. Besides, this approach occupies transmission bandwidth.

Developing content for programme-associated data requires significant manpower resources. As a result, the cost of delivering such applications is high, especially when different contents have to be developed for different TV programmes. It would also be desired that such programme-associated data contents could be reused for different video, audio and TV programmes.

Other attempts have been made which involve displaying something sometimes during audio playback, in particular for karaoke.

Japanese patent publication No. JP10-124071 describes a hard disk drive provided with a music data storage part which stores music data on pieces of karaoke music and a music information database which stores information regarding albums containing these pieces of music. In the music data, a flag is provided showing whether or not the music is one contained in an album. A controller determines if a song is one for which the album information is available. During an interval for a song where the information is available, data on the album name and music are displayed as a still picture.

Japanese patent publication No. JP10-268880 describes a system to reduce the memory capacity needed to store respective image data, by displaying still picture data and moving picture data together according to specific reference data. Genre data in the header part of Karaoke music performance data is used to refer to a still image data table to select pieces of still image data to be displayed during the introduction, interlude and postlude of the song. The genre data is also used to refer to a moving image data table to select and display moving image data at times corresponding to text data.

According to patent publication JP2001-350482A Karaoke data can include time interval information indicating time bands of non-singing intervals. For a performance, this information is compared with presentation time information relating to a spot programme. The spot programme whose presentation time is closest to the non-singing interval time is displayed during that non-singing interval.

Japanese patent publication No. JP7-271,387 describes a recording medium which records audio and video information together so as to avoid a situation in which a singer merely listens to the music and waits for the next step while a prelude and an interlude are being played by Karaoke singing equipment. A recording medium includes audio information for accompaniment music of a song and picture information for a picture displaying the text of the song. It also includes text picture information for a text picture other than the song text.

According to Japanese patent publication No. JP2001-350,482 Karaoke data can include time interval information indicating time bands of non-singing intervals. During playback, this information is compared with presentation time information relating to a spot programme. The spot programme whose presentation time is closest to the non-singing interval time is displayed during that non-singing interval.

### SUMMARY OF THE INVENTION

The present invention aims to provide the possibility of generating exciting and interesting visual displays. It may be desired to generate changing visual content relevant to the audio programme, for example beautiful scenery for music and relevant visual objects for various theme music, songs or lyrics.

According to one aspect of the present invention, there is provided a method of providing an audio signal with an associated video signal, comprising the steps of:

decoding an encoded audio stream to provide an audio signal and audio description data; and

providing an associated first video signal at least part of whose content is selected according to said audio description data.

Preferably said providing step comprises:

using said audio description data to select visual description data appropriate to the content of said audio signal; and

constructing video content from said selected visual description data; and providing said first video signal including the constructed video content.

The method may further comprise the step of extracting said visual description data from a transport stream, for instance an MPEG stream containing audio, video and the visual description data.

According to a second aspect of the present invention, there is provided a method of delivering programme-associated data to generate relevant visual display for audio contents, said method comprising the steps of:

encoding an audio signal and audio description data associated therewith into an encoded audio stream;

encoding visual description data; and

combining said encoded audio stream and said visual description data. The first and second aspects may be combined.

According to a third aspect of the present invention, there is provided apparatus for providing an audio signal with an associated video signal, comprising:

audio decoding means for decoding an encoded audio stream to provide an audio signal and audio description data; and

first video signal means for providing an associated first video signal at least part of whose content is selected according to said audio description data.

According to a fourth aspect of the present invention, there is provided a system for providing an audio signal with an associated video signal, comprising:

audio encoding means for encoding an audio signal and audio description data into an encoded audio stream

description data encoding means for encoding visual description data; and

combining means for combining said encoded audio stream and said visual description data.

The third and fourth aspects may be combined.

According to a fifth aspect of the present invention, there is provided a system for delivering programme-associated data to generate relevant visual display for audio contents, said system comprising:

audio encoding means for encoding an audio signal and audio description data associated therewith into an encoded audio stream;

video encoding means for encoding visual description data into an encoded video stream; and

combining means for combining said encoded audio and video streams.

In any of the above aspects, said visual description data is capable of comprising one or more of the group comprising: video clips, still images, graphics and textual descriptions. Alternatively or additionally, said visual description data may be classified for use with at least one of: at least one style of audio content, at least one theme of audio content and at least one type of event for which it might be suitable.

Said audio description data may comprise data relating to at least one of the group comprising: singer identification, group identification, music company identification, service provider identification and karaoke text. Alternatively or additionally, said audio description data may comprise data relating to the style of said audio signal. Alternatively or additionally again, said audio description data may comprise data relating to the theme of audio signal. As another possibility, said audio description data may comprise data relating to the type of event for which said audio signal might be suitable.

The audio description data may be within frames of said encoded audio stream, which frames also containing said audio signal. The encoded audio stream may be an MPEG audio stream. Where both occur, then said audio description data may be ancillary data within said MPEG audio stream.

In another aspect of the invention, any of the above apparatus or systems is operable according to any of the above methods.

Thus the invention provides an audio signal with an associated video signal. In particular, it provides an audio description data, transmitted with an audio signal as part of an audio stream, to select an appropriate video signal to accompany the audio signal.

This invention provides an effective means of adding further information relevant to the audio programme. It creates an option for the content provider to insert or modify relevant information describing the audio content for generating relevant visual content prior distributing or broadcasting. The programme-associated data, which may be carried in the ancillary data section of the audio elementary stream, provides a general description of the preferred classification or categories for use by the decoder to generate relevant visual display and interactive applications.

It may be desirable to insert programme-associated data to generate relevant, exciting and interesting visual displays for a listener, for example sports scenes or still pictures for sports related songs or lyrics. To generate such visual displays, a method of encoding and inserting the programme-associated data in the audio elementary streams, as well as a technique of decoding, interpreting and generating the visual display is provided. This invention provides an effective means of adding further information relevant to the audio programme. The programme-associated data carried in the ancillary data section of the audio elementary stream shall provide general description of the preferred classification or categories for use by the decoder to generate relevant visual display and interactive applications.

In one aspect, an MPEG audio stream is transmitted together with an MPEG video stream. The audio stream contains an audio signal together with associated audio description data as ancillary data. The video stream contains a video signal together with video description data (e.g. video clips, stills, graphics, text etc) as private data, the video description data not necessarily having anything to do with the video data with which it is transmitted. At reception, the audio and video streams are decoded. The video description data is stored in a memory. The audio signal is played. The audio description data is used to select appropriate video description data for the particular audio signal from the memory or other storage, or from the current incoming video description data. This is then displayed as the audio signal is played.

### INTRODUCTION TO THE DRAWINGS

The present invention will now be further described by way of non-limitative example with reference to the accompanying drawings, in which:

FIG. 1 is a block diagram of encoding audio and video description data;

FIG. 2 is a block diagram of a receiver of one embodiment of the invention; and

FIG. 3 is a schematic view of what happens at a receiver embodying the present invention;

### DETAILED DESCRIPTION

In this invention, programme-associated data describing an audio content is used as a basis to generate a visual display for a listener, for example: short video clips, scenes, images, advertisements, graphics, textual and interactive contents on festive events for songs or lyrics related to special occasions, where the visual display is relevant to the audio content. Methods of encoding and inserting the programme-associated data in audio elementary streams are used to generate such visual displays.

The programme-associated data is used to generate visual display relevant to the audio content. It can be distinctly categorised into two types of data: (i) audio description data for describing the audio content and (ii) visual description data for generating the visual display. The visual description data need not be developed for specific audio programme or audio description data.

(i) Audio Description Data

Audio description data gives general descriptions of the audio content such as the music theme, the relevant keyword for the song lyrics, titles, singer or company names, as well as the style of the music. The audio description data can be inserted in each audio frame or at various audio frames throughout the music or song duration, thus enabling different descriptions to be inserted at different sections of the audio programme.

(ii) Visual Description Data

The visual description data may contain short video clips, still images, graphics and textual descriptions, as well as data enabling interactive applications. The visual description data can be encoded separately from the audio description data and is delivered to the receiver as private data, residing in private tables of the transport or programme streams. The visual description data need not be developed for specific audio programme or audio description data. It can be developed for specific audio “style”, “theme”, “events”, and can also contain relevant advertising and interactive information.

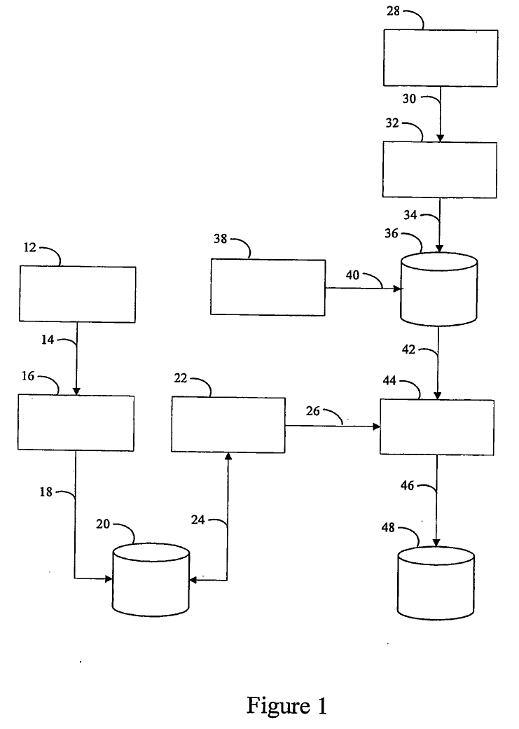

FIG. 1 is a block diagram of an encoding process for audio and visual description data according to an embodiment of the present invention.

An audio source 12 provides an audio signal 14 to an audio encoder 16, which encodes it into suitable audio elementary streams 18 for storing in a storage media 20, such as a set of hard discs.

An audio description data encoder 22 is a content creation tool for developing audio description data, such as general descriptions of the audio content. It is user operable or can work automatically, for example by analysing the musical and/or text content of the audio elementary streams (the tempo of music can for example be analysed to provide relevant information). The audio description data encoder 22 retrieves audio elementary streams from the storage media 20 and inserts the audio description data it creates into the ancillary data section within each frame of the audio elementary streams. After editing or inserting, the audio elementary stream containing the audio description data 24 is stored back in the storage media 20 for distribution or broadcast. The audio description data encoder 22 also produces identification and clock reference data 26 associated with the audio elementary stream containing the audio description data 24, and also stores these in the audio elementary stream.

A video/image source 28 provides a video/image signal 30 to a video/image encoder 32, which encodes it into a suitable data format 34 for storing in a storage media 36. Other data media 38 may also contribute suitable visual data 40 such as textual and graphics data. Archives of video clips, images, graphics and textual data 42 from the storage media 36 are supplied to and used by a visual description data encoder 44 for developing the visual content. The way this is done is platform dependent. For video clips they could be stored as MPEG-1/MPEG-2 or any one of a number of video formats that are supported. For graphics, they could be provided and stored as MPEG-4 or MPEG-7 description language or Java or such like. For text it could be provided and stored in unicode. For any of these, the definitions could even be proprietary.

The visual description data encoder 44 is a content creation tool for developing visual description data 46. The visual description data 46 is stored in a storage media 48 for distribution or broadcast. The visual description data 46 may be developed independently from the audio content. However, for applications where the visual description data 46 is intended to be executed together with associated audio description data, the identification code and clock reference 26 from audio description data encoder 22 are used to synchronise the decoding of the visual description data. For this, they are included in private defined descriptors which are embedded in the private sections carrying the visual description data.

During broadcast, whether by cable, optical or wireless transmission and whether as television or internet, audio elementary streams (including the audio description data) from audio storage media 20 are multiplexed with the visual description data as private data from video storage media 36 and video elementary streams (for instance containing a video) to form a transport stream. This is then channel coded and modulated to transmission.

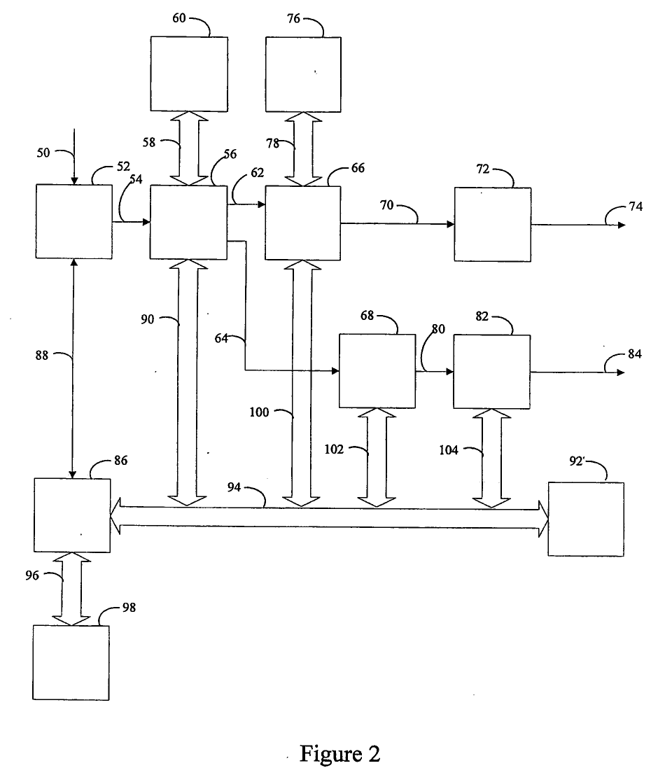

FIG. 2 is a block diagram of a receiver constructed in accordance with another embodiment of the invention for digital TV reception. An RF input signal 50 is received and passed on to a front-end 52 controlled to tune in the correct TV channel. The front-end 52 demodulates and channel decodes the RF input signal 50 to produce a transport stream 54.

A transport decoder 56 extracts a private section table from the transport stream 54 by identifying a unique 13-bit PID that contains the visual description data. The visual description data is channelled through the decoder's data bus 58 to be stored in a cyclic buffer 60. At the same time the transport decoder 56 also filters the audio elementary stream 62 and video elementary streams 64 to an MPEG audio decoder 66 and MPEG video decoder 68 respectively, from the transport stream 54.

The PID (Program Identification) is unique for each stream and is used to extract the audio stream, the video stream and the private section data containing the visual description data.

The MPEG audio decoder 64 decodes the audio elementary stream 62 to produce the decoded digital audio signal 70. The decoded digital audio signal 70 is sent to an audio encoder 72 to produce an analogue audio output signal 74. The ancillary data containing the audio description data in the audio elementary stream is filtered and stored in a cyclic buffer 76 via the audio decoder's data bus 78. The MPEG video decoder 68 decodes the video elementary stream 64 to produce the decoded digital video signal 80. The decoded digital video signal 80 is sent to a graphics processor and video encoder 82 to produce the video output signal 84.

The receiver host microprocessor 86 controls the front-end 52 to tune in the correct TV channel via an I²C bus 88. It also retrieves the visual description data from the cyclic buffer 60 through the transport decoder's data buses 58, 90. The visual description data is stored in a memory system 92 via the host data bus 94. The visual description data may also be downloaded from external devices such as PCs or other storage media via an external data bus 96 and interface 98.

The microprocessor 86 also reads the filtered audio description data from the cyclic buffer 76 via the audio decoder's data buses 78, 100. From the audio description data, it uses cognitive and search engines to select the best-fit visual description data from the system memory 92. The general steps used in selecting the best-fit may be as follows:
i. retrieve audio description data from the audio elementary stream. This is identified by the “audio_description_identification” value (described later);
ii. retrieve the “description_data_type” value (described later) to determine the type of data that follows;
iii. if the value of “description_data_type” is between 1 and 15, retrieve the “user_data_code” (Unicoded text) (described later) that describes the respective type of information. This information is used as the search criteria;
iv. if the value of “description_data_type” is any of 16, 17 and 18, retrieve the “description_data_code” (described later) to determine the search criteria. The “description_data_code” follows the definitions described in Tables 5, 6 and 7 (appearing later) for “description_data_type” values of 16, 17 and 18, respectively;
v. search the visual description database of memory 92 for best matches based on the search criteria. The database contains the visual description data files, stored in directories with filenames organised to allow the use of an effective search algorithm.

The operation of the MPEG video decoder 68 is also controlled by the microprocessor 86, via the decoder's data bus 102.

The graphics processor and video encoder module 82 has a graphics generation engine for overlaying textual and graphics, as well as performing mixing and alpha scaling on the decoded video. The operation of the graphics processor is controlled by the microprocessor 86 via the processor's data bus 104. Selected best-fit visual description data from the system memory 92 is processed under the control of the microprocessor 86 to generate the visual display using the features and capabilities of the graphics processor. It is then output as the sole video output signal or superimposed on the video signal resulting from the video elementary stream.

Thus, in use, the receiver extracts the private data containing the visual description data and stores in its memory system. When an audio programme is played (even at a later time), the receiver extracts the audio description data and uses that to search its memory system for relevant visual description data. The best-fit visual description data is selected to generate the visual display, which then appears during the audio programme.

MPEG is the preferred delivery stream for the present invention. It can carry several video and audio streams. The decoder can decode and render two audio-visual streams simultaneously.

The exact types of applications vary, depending on the broadcast or network services and hardware capabilities of the receiver. In TV applications such as a music video, which already includes a video signal, the programme-associated data may be used to generate relevant video clips, images, graphics and textual display and on screen displays (particularly interactive ones) as a first video signal and superimposing or overlaying it onto the music video (the second video signal). However, there will also be applications where the display of visual description data generated is the only signal displayed.

Additionally, when a user plays an audio programme containing audio description data, an icon appears on a display, indicating that valid programme-associated data is present. If the user presses a “Start Visual” button, the receiver searches for best-fit visual description data and generates the relevant visual display. By using pre-assigned remote control buttons, the user may navigate through interactive programs that are carried in the visual description data. An automatic option is also provided to start the best-fit visual display when incoming audio description data is detected.

The receiver is free to decide which visual description data shall be selected and how long each visual description data shall be played. Typically, search criteria are obtained from the audio description data when it is received. The visual description database is searched, based on the search criteria and a list of file locations is constructed, based on playing order. If the visual description play feature is enabled, this data is then played in this sequence. If another search criteria is obtained, the remaining visual description data is played out and the above procedure is followed to construct a new list of data matching the new criteria. User options are be included to refine the cognitive algorithm and searching process. In the implementations, the visual description data may be declarative (e.g. HTML) or procedural (e.g. JAVA), depending on the set of Application Programming Interface functions available for the receiver.

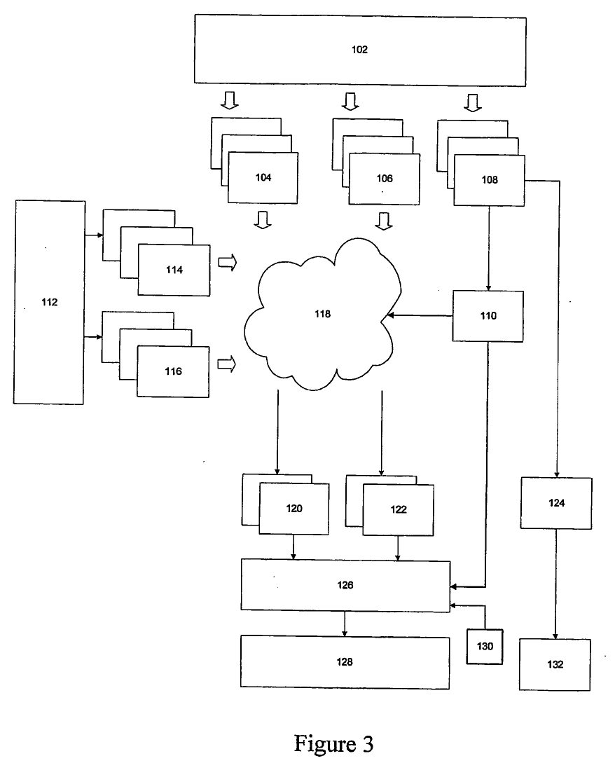

FIG. 3 is a schematic view of what happens at a receiver.

A digital television (DTV) source MPEG-2 stream 102 comprises visual description data 104, an encoded video stream 106 and an encoded audio stream 108 provides each stream, accessible separately. An MPEG-2 transport stream is preferred in DTV as it has robust error transmission. The visual description data is carried in an MPEG-2 private section. The encoded video stream is carried in MPEG-2 Packetised Elementary Stream (PES). The encoded audio stream also carries audio description data 110, which is separated out when the encoded audio stream is decoded.

Other sources 112, such as archives also provide second visual description data 114 and a second encoded video stream 116.

The two sets of visual description data and the two encoded video streams are provided to a search engine 118 as searchable material, whilst the audio description data is also input to the search engine as search information. Visual description data that is selected is interpreted by a decoder to construct a video signal 120 (usually graphics or short video clips). It uses much less data to construct this video signal compared with the video stream. An encoded video signal that is selected is decoded to produce a second video signal 122.

In parallel, the decoding of the encoded audio stream, as well as providing audio description data 110 also provides audio signal 124.

A renderer 126 receives the two video signals and, because it is constructed in various layers (including graphics and OSD), is able to provide a combined video signal 128 in which multiple video signals overlap. The renderer also has an input from the audio description data. The combined video signal can be altered by a user select 130.

The audio signal is also rendered separately to produce sound 132.

An example of a format for the audio description data will now be described.

The audio description data is placed in an ancillary data section within each frame of an audio elementary stream. Table 1 shows the syntax of an audio frame as defined in ISO/IEC 11172-3 (MPEG-Audio).

TABLE 1
Syntax of audio frame

| Syntax | No. of bits |
|---|---|
| frame( ) | |
| { | |
| header | 32 |
| error_check | 16 |
| audio_data( ) | |
| ancillary_data( ) | no_of_ancillary_bits |
| } | |

The ancillary data is located at the end of each audio frame. The number of ancillary bits equals the available number of bits in an audio frame minus the number of bits used for header (32 bits), error check (16 bits) and audio. The numbers of audio data bits and ancillary data bits are both variable. Table 2 shows the syntax of the ancillary data used to carry the programme-associated data. The ancillary data is user definable, based on the definitions shown later, according to the audio content itself.

TABLE 2
Syntax of ancillary data

| Syntax | No. of bits |
|---|---|
| ancillary_data( ) | |
| { | |
| if ( (layer==1) \|\| (layer==2) ) { | |
| for (b=0; b<no_of_ancillary_bits; b++) { | |
| ancillary_bit | 1 |
| } | |
| } | |
| } | |

The audio description data is created and inserted as ancillary data by the content creator or provider prior to distribution or broadcast.

Table 3 shows the syntax of the audio description data in each audio frame, residing in the ancillary data section.

TABLE 3
Syntax of audio description data

| Syntax | No. of bits |
|---|---|
| audio_description_data( ) | |
| { | |
| audio_description_identification | 13 |
| distribution_flag_bit | 1 |
| description_data_type | 5 |
| description_data_code | 5 |
| if (description_data_type == 0) { | |
| audiovisual_pad_identification | 16 |
| audiovisual_clock_reference | 16 |
| } | |
| else if (description_data_type <= 15) { | |
| user_data_code( ) | |
| } | |
| } | |

The semantic definitions are:
audio_description_identification—A 13-bit unique identification for user definable ancillary data carrying audio description information. It shall be used for checking the presence of audio description data relevant to the audio content.
distribution_flag_bit—This 1-bit field indicates whether the following audio description data within the audio frame can be edited or removed. A ‘1’ indicates no modification is allowed. A ‘0’ indicates editing or removal of the following audio description data is possible for re-distribution or broadcast.
description_data_type—This 5-bit field defines the type of data that follows. The data type definitions are tabulated in Table 4.
description_data_code—This 5-bit field contains the predefined description code for description_data_type greater than 15. It is undefined for description_data_type between 0 to 15.
audiovisual_pad_identification—A 16-bit programme-associated data identification for application where the audio content, including the audio description data, comes with optional associated visual description data. The receiver may look for matching visual description data having the same identification in the receiver's memory system.
audiovisual_clock_reference—This 16-bit field provides a clock reference for the receiver to synchronise decoding of the visual description data. Each count is 20 msec.
user_data_code—User data in each audio frame to describe text characters and Karaoke text and timing information.

Table 4 shows the definitions of the description_data_type that defines the data type for description_data_code.

TABLE 4
Definitions of description_data_type

| Value | Definitions | Data Loop |
|---|---|---|
| 0 | Identification followed by Clock Reference. | |
| 1 | Title description. | √ |
| 2 | Singer/Group name description. | √ |
| 3 | Music company name description. | √ |
| 4 | Service provider description. | √ |
| 5 | Service information description | √ |
| 6 | Current event description | √ |
| 7 | Next event description | √ |
| 8 | General text description | √ |
| 9-12 | Reserved | √ |
| 13 | Karaoke text and timing description | √ |
| 14 | Web-links | √ |
| 15 | Reserved | √ |
| 16 | Style | |
| 17 | Theme | |
| 18 | Events | |
| 19 | Objects | |
| 20-31 | Reserved | |

A value of 0 indicates that the codes after description_data_code shall contain audiovisual_pad_identification and audiovisual_clock_reference data. The former provides a 16-bit unique identification for applications where the present audio content comes with optional associated visual description data having the same identification number. When the receiver detects this condition, it may look for matching visual description data having the same identification in its memory system. If no matching visual description data is found, the receiver may filter incoming streams for the matching visual description data. The audiovisual_clock_reference provides a 16-bit clock reference for the receiver to synchronise decoding of the visual description data. Each count is 20 msec. With 16-bit clock reference and a resolution of 20 msec per count, the maximum total time without overflow is 1310.72 sec, and shall be sufficient for each audio music or song duration.

Table 5, 6 and 7 list the descriptions of the pre-defined description_data_code for “style”, “theme” and “events” data type respectively. The description_data_type and description_data_code shall be used as a basis for implementing cognitive and searching processes in the receiver for deducing the best-fit visual description data to generate the visual display. The selection of visual description data may be different even for the same audio elementary stream, as it is up to the receiver's cognitive and search engines' implementations. User options may be added to specify preferred categories of visual description data.

TABLE 5
Definitions of description_data_code for description_data_type
equals “style”

| Value | Definitions |
|---|---|
| 0 | Reserved |
| 1 | Children's |
| 2 | Christian & Gospel |
| 3 | Classical |
| 4 | Country |
| 5 | Dance |
| 6 | Folk |
| 7 | Instrumental |
| 8 | International |
| 9 | Jazz |
| 10 | Karaoke |
| 11 | Latin |
| 12 | Music |
| 13 | New Age |
| 14 | Opera |
| 15 | Pop |
| 16 | Rap |
| 17 | Rock |
| 18 | Sentimental |
| 19 | Soul |
| 20 | Soundtracks |
| 21-31 | Reserved |

TABLE 6
Definitions of description_data_code for description_data_type
equals “theme”

| Value | Definitions |
|---|---|
| 0 | Reserved |
| 1 | Action and adventure |
| 2 | Art and architecture |
| 3 | Beach, wet and wild |
| 4 | Business |
| 5 | Family |
| 6 | Food and wine |
| 7 | Fun |
| 8 | Health and beauty |
| 9 | Home and garden |
| 10 | Horror and suspense |
| 11 | Kids |
| 12 | Leisure and entertainment |
| 13 | Love and romance |
| 14 | Music and musical |
| 15 | Outdoors and nature |
| 16 | Science fiction and fantasy |
| 17 | Sports |
| 18 | Supermarket |
| 19 | Teens |
| 20 | Travel |
| 21-31 | Reserved |

TABLE 7
Definitions of description_data_code for description_data_type
equals “events”

| Value | Definitions |
|---|---|
| 0 | Reserved |
| 1 | Birthday |
| 2 | Children's day |
| 3 | Chinese new year |
| 4 | Christmas day |
| 5 | Festive Celebrations |
| 6 | National day |
| 7 | New year's day |
| 8 | Sales |
| 9 | Sports events |
| 10 | Wedding day or anniversary |
| 11-23 | Reserved |

The audio description data may be used to describe text and the timing information in audio content for Karaoke application. Table 8 shows the syntax of the karoke_text_timing_information residing in the ancillary data section of the audio frame. Table 8 falls into “user_data_code” in Table 3. This happens when “description_data_type”=13 in Table 4.

TABLE 8
Syntax of karaoke_text_timing_description( )

| Syntax | No. of bits |
|---|---|
| karaoke_text_timing_description( ) | |
| { | |
| karaoke_clock_reference | 16 |
| iso_639_language_code | 24 |
| start_display_time | 16 |
| audio_channel_format | 2 |
| upper_text_length | 6 |
| for (i=0;i<upper_text_length;i++) { | |
| upper_text_code | 16 |
| } | |
| reserved | 2 |
| lower_text_length | 6 |
| for (i=0;i<lower_text_length;i++){ | |
| lower_text_code | 16 |
| } | |
| for (i=0;i<upper_text_length+1;i++){ | |
| upper_time_code | 16 |
| } | |
| for (i=0;i<lower_text_length+1;i++){ | |
| lower_time_code | 16 |
| } | |
| } | |

Audio channel information is provided in Table 9

TABLE 9
Definitions of audio_channel_format

| Value | Definitions |
|---|---|
| 0 | Use default audio settings. |
| 1 | Music at left channel. Vocal at right channel. |
| 2 | Music at right channel. Vocal at left channel. |
| 3 | Reserved. |

The semantic definitions are:
karaoke_clock_reference—This 16-bit field provides a clock reference for the receiver to synchronise decoding of the Karaoke text and time codes. It is used to set the current decoding clock reference in the decoder. Each count is 20 msec.
iso_{—}639_Language_Code—This 24-bit field contains 3 character ISO 639 language code. Each character is coded into 8 bits according to ISO 8859-1.
start_display_time—This 16-bit field specifies the time for displaying the two text rows. It is used with reference to the karaoke_clock_reference. Each count is 20 msec.
audio_channel_format—This 2-bit field indicates the audio channel format for use in the receiver for setting the left and right output. See Table 9 for definitions.
upper_text_length—This 6-bit field specifies the number of text characters in the upper display row.
upper_text_code—The code defining the text characters in the upper display row (from 0 to 64).
lower_text_length—This 6-bit field specifies the number of text characters in the lower display row.
lower_text_code—The code defining the text characters in the lower display row (from 0 to 64).
upper_time_code—This 16-bit field specifies the scrolling information of the individual text character in the upper display row. It is used with reference to the karaoke_clock_reference. Each count is 20 msec.
lower_time_code—This 16-bit field specifies the scrolling information of the individual text character in the lower display row. It is used with reference to the karaoke_clock_reference. Each count is 20 msec.

The karaoke_clock_reference starts from count 0 at the beginning of each Karaoke song. For synchronisation of Karaoke text with audio, the audio description data encoder is responsible for updating the karaoke_clock_reference and setting start_display_time, upper_time_code and lower_time_code for each Karaoke song.

In the receiver, the timing for text display and scrolling is defined in the start_display_time, upper_time_code and lower_time_code fields. The receiver's Karaoke text decoder timer shall be updated to karaoke_clock_reference. When the decoder count matches start_display_time, the two rows of text shall be displayed without highlighting. The scrolling information is embedded in the upper_time_code and lower_time_code fields. They are used for highlighting the text character display to make the scrolling effect. For example, the decoder will use the difference between the upper_time_code[n] and upper_time_code[n+1] to determine the scroll speed for text character in the upper row at nth position. A pause in scrolling is done by inserting a space text character. At the end of scrolling in the lower row, the decoder remove the text display and the decoder process repeats with the next start_display_time.

With 16 bit time code and a resolution of 20 msec per count, the maximum total time without overflow is 1310.72 sec or 21 minutes and 50.72 sec. The specification does not restrict the display style of the decoder model. It is up the decoder implementation to use the start_display_time and the time code information for displaying and highlighting the Karaoke text. This enables various hardwares with different capabilities and On-Screen-Display (OSD) features to perform Karaoke text decoding.

The visual description data may be in various formats, as mentioned earlier. This tends to be platform dependent. For example in MHP (Multimedia Home Platform) receivers, JAVA and HTML are supported.

In audio only applications, it may be desirable to insert programme-associated data to generate a relevant, exciting and interesting visual display for a listener. To generate such a visual display, a method of encoding and inserting the programme-associated data in the audio elementary streams, as well as a technique of decoding, interpreting and generating the visual display has been introduced.

Developing visual content relevant to the audio or TV programme requires significant resources. Getting the viewer to access these additional data service information is important for successful commercial implementations. In most cases, the viewer would find a TV programme uninteresting after having watched the programme and is less likely to be watching it many more times. However, for audio applications, the listener is more likely to repeat the same music and song over and over again. Thus, the solution of generating visual display relevant to the audio content includes the option of generating different displays to arouse the viewer's attention, even when playing the same audio content. To reduce the cost of content development for generating the visual display, the present inventio enables sharing and reuse of the programme-associated data among different audio and TV applications.

In TV applications such as music video, the programme-associated data carried in the audio elementary stream may be used to generate relevant graphics and textual display on top of the video. Thus, one embodiment provides a method that enables additional visual content superimposing or overlaying onto the video.

The implementations are mainly software. Applications for editing audio description data can be used to assist the content creator or provider to insert relevant data in the audio elementary stream. Software development tools can be used to generate the visual description data for inserting in the transport or programme streams as private data. In the receiver, when the audio programme containing the audio description data is played, the receiver extracts the audio description data and searches its memory system for relevant visual description data that have been extracted or downloaded previously. The user may also generate individual visual description data. The best-fit visual description data is selected to generate the visual display.

With current advances in technologies, especially in the area of digital TV, there are many opportunities to develop visual and interactive programmes on top of a background video. This invention provides an effective means of adding further information relevant to the audio programme. It creates an option for the content creator to insert or modify relevant descriptive information or links for generating relevant visual content prior distributing or broadcasting. The programme-associated data carried in the ancillary data section of the audio elementary stream provides general description of the preferred classification or categories for use by the decoder to generate relevant visual display and interactive applications. A commercially viable scheme that fits into digital audio and TV broadcasting, as well as other multimedia platforms is beneficial to content providers, broadcasters and consumers. Thus the invention can be used in multimedia applications such as in digital TV, digital audio broadcasting, as well as in the Internet domain, for distribution of programme-associated data for audio contents.

In terms of positioning the constructed visual description data, this can be placed as desired, for instance as is described in the co-pending patent application filed by the same applicant on 4 Oct. 2002 and entitled Visual Contents in Karaoke Applications, the entire contents of which are herein incorporated by reference.

Although only single embodiments of an encoder and a receiver and of the audio description data have been described, other embodiments and formats can readily be used, falling within the scope of what has been invented, both as claimed and otherwise.

1-83. (canceled)

84. A method of providing an audio signal with an associated video signal, comprising the steps of:
decoding an encoded audio stream to provide an audio signal and audio description data; and
providing an associated first video signal at least part of whose content is selected according to said audio description data,
wherein said providing step comprises:
using said audio description data to select visual description data appropriate to the content of said audio signal;
constructing video content from said selected visual description data; and providing said first video signal including the constructed video content.

85. A method according to claim 84, further comprising the step of extracting said visual description data from a transport stream.

86. A method according to claim 85, wherein said visual description data is extracted from private data within said transport stream.

87. A method according to claim 85, wherein said transport stream further comprises said encoded video and audio streams.

88. A method according to claim 87, wherein said audio description data in said encoded audio stream includes identification data and clock reference data for use with said visual description data in said same transport stream.

89. A method according to claim 88, wherein descriptors corresponding to said identification data and clock reference data are stored in private sections of said visual description data.

90. A method according to claim 87, wherein said audio stream, said video stream and said visual description data are multiplexed into said transport stream which is transmitted in a television signal.

91. A method according to claim 87, wherein said step of using said audio description data to select appropriate visual description data comprises selecting visual description data from the same transport stream.

92. A method according to claim 83, further comprising the step of storing said extracted visual description data.

93. A method according to claim 92, wherein said step of using said audio description data to select appropriate visual description data comprises selecting stored visual description data.

94. A method according to claim 83, further comprising the step, prior to the step of extracting said visual description data, of encoding said visual description data.

95. A method of delivering programme associated data to generate relevant visual display for audio contents, said method comprising the steps of:
encoding an audio signal and audio description data associated therewith into an encoded audio stream;
encoding visual description data; and combining said encoded audio stream and said visual description data;
encoding a second video signal into an encoded video stream;
combining said encoded video stream with said visual description data and said encoded audio stream into a transport stream; and
further comprising transmitting said transport stream in a television signal.

96. A method according to claim 95, wherein said visual description data does not relate to the encoded video signal in the same transport stream.

97. A method according to claim 95, wherein said visual description data does not relate to the encoded audio signal in the same transport stream.

98. A method according to claim 95, wherein said transport stream is an MPEG stream.

99. A method according to claim 83, wherein said visual description data comprises one or more of the group comprising: video clips, still images, graphics and textual descriptions.

100. A method according to claim 83, wherein said visual description data is classified for use with at least one of at least one style of audio content, at least one theme of audio content and at least one type of event for which it might be suitable.

101. A method according to claim 83, wherein said audio description data comprises data relating to at least one of the group comprising: singer identification, group identification, music company identification, service provider identification and karaoke text.

102. A method according to claim 83, wherein said audio description data comprises data relating to the style of said audio signal.

103. A method according to claim 83, wherein said audio description data comprises data relating to the theme of audio signal.

104. A method according to claim 83, wherein said audio description data comprises data relating to the type of event for which said audio signal might be suitable.

105. A method according to claim 83, wherein said audio description data is encoded within frames of said encoded audio stream, which frames also contain said audio signal.

106. A method according to claim 104, wherein said audio description data is encoded as ancillary data within audio frames of said audio stream.

107. Apparatus for providing an audio signal with an associated video signal, comprising:
audio decoding means for decoding an encoded audio stream to provide an audio signal and audio description data; and
first video signal means for providing an associated first video signal at least part of whose content is selected according to said audio description data,
wherein said first signal means comprises:
selecting means for using said audio description data to select visual description data appropriate to the content of said audio signal;
constructing means for constructing video content from said selected visual description data; and
means for providing said first video signal including the constructed video content.

108. An apparatus according to claim 107, further comprising extracting means for extracting said visual description data from a transport stream.

109. Apparatus according to claim 108, wherein said extracting means is operable to extract said visual description data from private data within said transport stream.

110. Apparatus according to claim 107, operable when said transport stream further comprises said encoded video and audio streams.

111. Apparatus according to claim 110, operable when said audio description data in said encoded audio stream includes identification data and clock reference data for use with said visual description data in said same transport stream.

112. Apparatus according to claim 111, operable when descriptors corresponding to said identification data and clock reference data are stored in private sections of said visual description data.

113. Apparatus according to claim 107, operable when said audio stream, said video stream and said visual description data are multiplexed into said transport stream which is transmitted in a television signal.

114. Apparatus according to claim 110, wherein said selecting means is operable to select appropriate from the same transport stream as the visual description data.

115. Apparatus according to claim 107, further comprising storing means for storing said extracted visual description data.

116. Apparatus according to claim 115, wherein said selecting means is operable to select appropriate visual description data from the storing means.

117. Apparatus according to claim 107, wherein said visual description data comprises one of: video clips, still images, graphics or textual descriptions.

118. Apparatus according to claim 107, wherein said visual description data is classified for use with at least one of: at least one style of audio content, at least one theme of audio content and at least one type of event for which it might be suitable.

119. Apparatus according to claim 107, wherein said audio description data comprises data relating to at least one of singer identification, group identification, music company identification, service provider identification and karaoke text.

120. Apparatus according to claim 107, wherein said audio description data comprises data relating to the style of said audio signal.

121. Apparatus according to claim 107, wherein said audio description data comprises data relating to the theme of audio signal.

122. Apparatus according to claim 107, wherein said audio description data comprises data relating to the type of event for which said audio signal might be suitable.

123. Apparatus according to claim 107, wherein said audio encoding means is operable to encode said audio description data within frames of said encoded audio stream, which frames also contain said audio signal.

124. A system for delivering programme associated data to generate relevant visual display for audio contents, comprising:
audio encoding means for encoding an audio signal and audio description data associated therewith into an encoded audio stream;
description data encoding means for encoding visual description data; and
combining means for combining said encoded audio stream and said visual description data;
video encoding means for encoding a second video signal into an encoded video stream;
wherein said combining means is operable to combine said visual description data, said encoded audio stream and said encoded video stream into a transport stream; and
wherein said combining means is operable to combine said visual description data with encoded video signal to which it does not relate, in the same transport stream.

125. A system according to claim 124, wherein said combining means is operable to combine said visual description data with encoded audio signal to which it does not relate, in the same transport stream.

126. A system according to claim 124, wherein said transport stream is an MPEG stream.

127. A system according to claim 124, wherein said visual description data comprises one or more of: video clips, still images, graphics and textual descriptions.

128. A system according to claim 124, wherein said visual description data is classified for use with at least one of: at least one style of audio content, at least one theme of audio content and at least one type of event for which it might be suitable.

129. A system according to claim 124, wherein said audio description data comprises data relating to at least one of singer identification, group identification, music company identification, service provider identification or karaoke text.

130. A system according to claim 124, wherein said audio description data comprises data relating to the style of said audio signal.

131. A system according to claim 124, wherein said audio description data comprises data relating to the theme of audio signal.

132. A system according to claim 124, wherein said audio description data comprises data relating to the type of event for which said audio signal might be suitable.

133. A system according to claim 124, wherein said audio encoding means is operable to encode said audio description data within frames of said encoded audio stream, which frames also contain said audio signal.

134. A system or apparatus according to claim 132, wherein said audio encoding means is operable to encode said audio description data as ancillary data within audio frames of said audio stream.

135. A method of delivering programme-associated data to generate relevant visual display for audio contents, said method, comprising:
encoding audio description data relevant to the audio contents in one or more audio elementary streams; and
encoding visual description data created for audio contents for generating a visual display; wherein
said visual description data is relevant to at least one of the groups comprising: a generic audio style, a generic audio theme, special events and specific objects.

136. The method of claim 135, further comprising the preceding steps of:
specifying preferred visual displays for the frames of said audio elementary stream; and
constructing said audio description data using information relating to said preferred visual displays.

137. The method of claim 135, wherein said specifying step comprises identifying at least one of
the style of the audio content;
the theme of said audio frame;
an event associated with said audio frame; and
keywords in any lyrics of said audio frame;
and further comprising specifying a most preferred visual display after the identifying step.

138. The method of claim 136, wherein said specifying step comprises specifying the preferred visual display for each of said frames.

139. The method of claim 135, further comprising inserting said audio description data in ancillary data sections of said audio frames in said audio elementary stream.

140. The method of claim 135, wherein said constructing step comprises:
specifying a unique identification code;
specifying a distribution flag for indicating distribution rights;
specifying the data type;
inserting text description describing the audio content;
inserting data code describing said preferred visual display; and
inserting user data code for generating the visual display.

141. The method of claim 135, further comprising:
encoding background video into a video elementary stream; and
encoding the audio contents into said one or more audio elementary streams, and wherein said audio description data describes said audio contents.

142. The method of claim 135, wherein the step of encoding visual description data comprises encoding the visual description data into private data to be carried in a transport stream.

143. The method of claim 141, further comprising multiplexing said video elementary stream, said one or more audio elementary streams and said private data into a transport stream for broadcast.

144. The method of claim 135, further comprising delivering said audio description data and said video description data to a receiver for decoding and for generating said visual display.

145. The method of claim 135, further comprising the step of providing said visual description data by downloading it from external media or creating it at a user terminal.

146. A method of delivering Karaoke text and timing information to generate a Karaoke visual display for an audio song, said method comprising:
encoding said audio song into an audio elementary stream;
inserting clock references for use in synchronising decoding of said Karaoke text and timing information with said audio song in said audio elementary stream;
inserting channel information of said audio song in said audio elementary stream;
inserting said Karaoke text information for said audio song in said audio elementary stream; and
inserting said Karaoke timing information for generating scrolling said Karaoke text in said audio elementary stream.

147. The method of claim 83, being used in digital TV broadcast and or reception.

148. The method of claim 135, being used in digital TV broadcast and or reception.

149. Apparatus for generating relevant visual display for audio contents, comprising:
storing means for storing visual description data that generate the visual display;
playing means for playing said audio contents carried in an audio elementary stream;
extracting means for extracting audio description data for said audio contents from said audio elementary stream;
selecting means for selecting preferred visual description data from said storing means using information from said audio description data; and
executing means for executing said visual description data to generate said visual display.

150. Apparatus according to claim 149, wherein said executing means is operable to execute interactive programmes carried in said visual description data.

151. Apparatus according to claim 149, further comprising:
receiving means for receiving a multiplexed transport stream containing one or more of said audio elementary streams and said visual description data carried as private data.

152. A system for connecting audio and visual contents, comprising:
downloading means for downloading audio elementary streams for said audio contents and for downloading visual description data;
creating and editing means for creating and editing audio description data relevant to said audio contents carried in said audio elementary streams and for creating and editing visual description data for generating said visual contents;
selecting means for selecting said visual description data that best fits the audio description data for generating a visual display;
user operable means for modifying the behaviour of said selecting means; and processor means for executing said visual description data to generate the display.

153. A system according to claim 152, wherein said selecting means comprise cognitive and search engines.

154. A system according to claim 152, being a home entertainment system.
